(19) United States
(12) Patent Application Publication
(10) Pub. No.: US 2025/0129733 A1
(43) Pub. Date: Apr. 24, 2025

(54) HEATING ELEMENT FOR EXHAUST LINE

(71) Applicant: FAURECIA SYSTEMES D'ECHAPPEMENT, NANTERRE (FR)

(72) Inventors: Marc LEROUX, SAINTE SUZANNE (FR); Jörg VEITTINGER, Augsburg (DE); Michael SCHMIDT, MEITINGEN (DE)

(21) Appl. No.: 18/915,489

(22) Filed: Oct. 15, 2024

(30) Foreign Application Priority Data
Oct. 18, 2023 (FR) 2311272

(51) Int. Cl. F01N 3/20; B01D 53/94

(52) U.S. Cl. CPC F01N 3/2026; B01D 53/9431; B01D 2257/404; B01D 2258/01

(57) ABSTRACT

A heating element for an exhaust line includes a substantially tubular housing that defines a passage section for the exhaust gases and at least two heating discs arranged across the passage section to force the exhaust gases to pass through the at least two heating discs. A connector supports the at least two heating discs and provides an electrical connection between the at least two heating discs.

### CROSS-REFERENCE TO RELATED APPLICATION

This application is a U.S. non-provisional application claiming the benefit of French Application No. 2311272, filed on Oct. 18, 2023, which is incorporated herein by reference in its entirety.

### TECHNICAL FIELD

The disclosure relates to a heating element for an exhaust line. Such a heating element is typically electrically heated. It is also known as EHC (Electrically Heated Catalyst)

### BACKGROUND

Such a heating element is typically used to clean up the exhaust gases produced by combustion within an engine, circulating in an exhaust line. Nitrogen oxides, (NOx), the polluting compounds produced by the combustion of hydrocarbons, are most often removed by a catalytic reduction reaction. This reaction requires a catalyst, including precious metals. A hot catalytic converter transforms the NOx contained in exhaust gases, with the addition of a reducing fluid—usually an aqueous urea solution—into non-polluting nitrogen N₂ and water H₂0.

For the reduction reaction to be effective, the catalyst must be very hot. This is ensured in steady-state operation, as the catalytic converter is heated by the hot exhaust gases from combustion. However, this is not the case in the initial phases following engine start-up.

It is also known to place, in an exhaust line, upstream of a catalytic converter, a heating element capable of heating the exhaust gases passing through it, in order to also heat the catalytic converter itself.

One possible design principle for such a heating element is a heating disc, perforated to allow exhaust gases to pass through. The heating disc is arranged across the flow section of the exhaust line. The heating disc is heated so as to heat the exhaust gases as they pass through.

In one possible embodiment, heating is achieved by applying an electric current between two end points of the metal heating disc, in order to heat it by Joule effect.

It has recently become apparent that, in terms of performance and durability, a heating element with more than one heating disc can be produced in series, both fluidically and electrically. This raises problems of mechanical support for the heating discs and their electrical connection.

The disclosure offers several embodiments for optimized mechanical support and electrical connection.

### SUMMARY

An exhaust line heating element is provided that comprises a substantially tubular housing defining a passage section for the exhaust gases, accommodating at least two heating discs arranged across the passage section so as to force exhaust gases to pass through said at least two heating discs, wherein the heating element further comprises a connector supporting said at least two heating discs and providing an electrical connection between said at least two heating discs.

Particular features or embodiments, usable alone or in combination, are:
the connector comprises a first wheel flange and a central electrode, the first wheel flange comprising a rim, substantially conforming to the periphery of the passage cross-section for the exhaust gases, a hub adapted to support the central electrode and spokes connecting the rim to the hub, the central electrode electrically connecting the respective centers of said at least two heating discs,
the rim of the first wheel flange has an L-shaped cross-section, with one arm of the L arranged radially and the other arm of the L arranged axially, a radial arm of the L forming a first bearing face capable of bearing axially against the periphery of a first disc of said at least two heating discs,
the first wheel flange is arranged outside the at least two heating discs, with the radial arm of the L bearing against the adjacent disc and an axial arm of the L pointing outwards,
the first wheel flange is welded to the adjacent disc,
a first insulating rim is arranged axially between said at least two heating discs and the hub is electrically insulated relative to the central electrode,
the first wheel flange is arranged between said at least two heating discs, the radial arm of the L bearing against a first disc and the axial arm of the L pointing towards a second disc,
the first wheel flange is electrically insulated from the first disc by a second insulating rim, axially interposed therebetween,
the first wheel flange is electrically insulated from the housing radially by a first peripheral mat,
the connector further comprises a single flange comprising a rim with an L-shaped cross-section, reversed relative to the cross-section of the rim of the first wheel flange so as to form a second bearing face capable of bearing against the periphery of a second disc of said at least two heating discs and electrically insulated from said second disc by a third insulating rim axially interposed therebetween,
the single flange is electrically isolated from the housing radially by a second peripheral mat,
the connector comprises a first wheel flange and a second wheel flange, mounted head-to-tail between two of said at least two heating discs, electrically connected to one another, a wheel flange comprising a rim, substantially conforming to the periphery of the passage cross-section for the exhaust gases, a hub and spokes connecting the rim to the hub, a hub being electrically connected to the respective center of the adjacent disc and a rim being electrically insulated from the adjacent disc by an insulating rim axially interposed therebetween,
the connector comprises a cylindrical slice of metallic foam, arranged between a first disc and a second disc of said at least two heating discs, electrically connected with the first center of the first disc and with the second center of the second disc, axially electrically insulated from the rest of the first disc by a second insulating rim and axially electrically insulated from the rest of the second disc by a third insulating rim, the metallic foam being preferentially coated to produce a catalytic effect,
the heating element further comprises, for each of said at least two heating discs, a peripheral electrode electrically connected to the periphery of said disc,
a wheel well further comprises a mixer,
the connector comprises a connector of substantially tubular shape, conforming internally to the shape of the housing, so as to provide an electrical connection between the respective peripheries of said at least two heating discs,
the heating element further comprises, for each of said at least two heating discs, a central electrode respectively electrically connected to the center of the disc, from the outside,
the connector further comprises a catalytic brick arranged between said at least two heating discs.

### BRIEF DESCRIPTION OF THE DRAWINGS

The disclosure will be better understood on reading the following description, given solely by way of example, and with reference to the appended figures in which:

FIG. 1 shows a sectional view of a heating element along its axis, according to a first embodiment;

FIG. 2 shows a perspective view of the heating element shown in FIG. 1;

FIG. 3 shows a sectional view along its axis of a heating element according to a second embodiment;

FIG. 4 shows a perspective view of the heating element shown in FIG. 3;

FIG. 5 shows a sectional view along its axis of a heating element according to a third embodiment;

FIG. 6 shows a perspective view of the heating element shown in FIG. 5;

FIG. 7 shows a sectional view of a heating element along its axis according to a variant of the third embodiment;

FIG. 8 shows a perspective view of the heating element in FIG. 7;

FIG. 9 shows a sectional view of a heating element along its axis in a fourth embodiment;

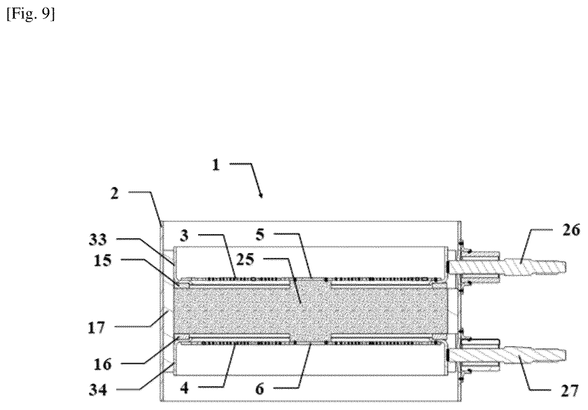

FIG. 10 shows a perspective view of the heating element in FIG. 9;

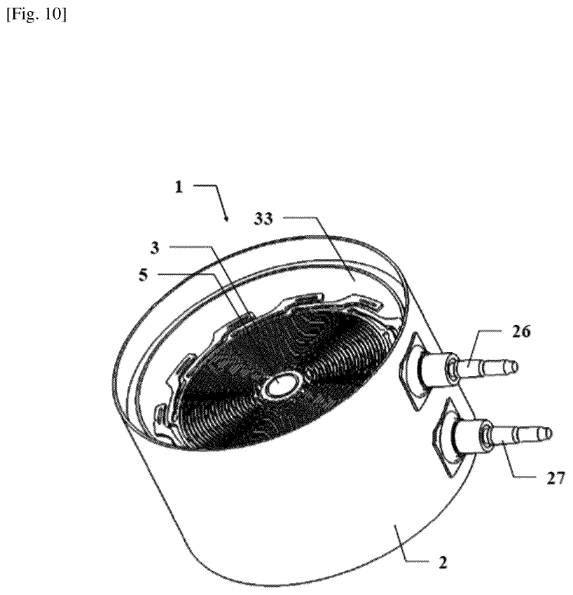

FIG. 11 shows a sectional view along its axis of a heating element according to a fifth embodiment; and

FIG. 12 shows a perspective view of the heating element in FIG. 11.

### DETAILED DESCRIPTION

Throughout this document, the terms “radial” and “axial” are used in relation to the axis of the exhaust line or housing. The term “axial” qualifies an element substantially aligned with said axis, while “radial” qualifies an element substantially perpendicular to said axis.

The disclosure relates to a heating element 1 for an exhaust line. Such a heating element 1 comprises a substantially tubular housing 2, integrated into or forming a section of the exhaust line, defining a passage section for the exhaust gases. This housing 2 accommodates at least two heating discs 3, 4 arranged across the passage section so as to force the exhaust gases to pass through said at least two heating discs 3, 4.

According to another feature, the heating element 1 also comprises a protective cover. The heating element 1 also includes a connector that has two functions: mechanical support and electrical connection. The connector provides mechanical support for said at least two discs 3, 4. It also provides an electrical connection between said at least two discs 3, 4.

For heating purposes, discs 3, 4 must be electrically connected at two points, preferably at the ends, so that the electric current flows as evenly as possible across the entire surface of said at least two discs 3, 4. According to a feature used here, a first point is located at the center 5, 6 of the disc 3, 4 and the other point is located at the periphery of the disc 3, 4. This ensures a substantially uniform radial flow of electric current between the two points.

The two discs 3, 4 are advantageously electrically connected in series.

Several embodiments of this connector and support member are envisaged.

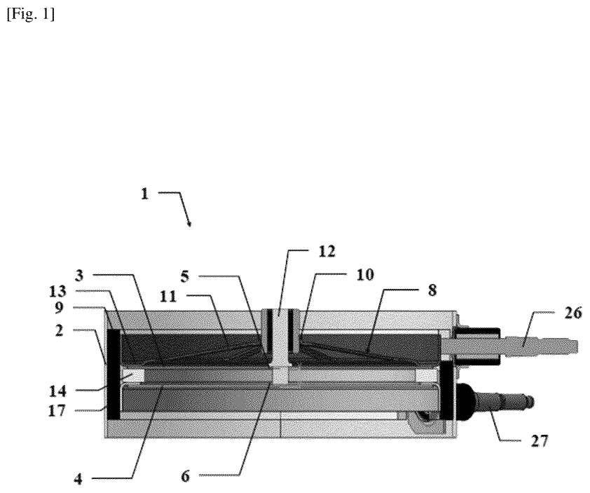

According to a feature used in several embodiments, more particularly illustrated in FIGS. 1-4, in one example, the connector comprises a first wheel flange 8 and a central electrode 12.

The first wheel flange 8 is wheel shaped. It comprises a rim 9, substantially conforming to the periphery of the exhaust gas passage section, a hub 10, preferentially central, and spokes 11 connecting the rim 9 to the hub 10. The hub 10 accommodates and holds the central electrode 12. The central electrode 12 provides an electrical connection between the center 5 of a first disc 3 and the center 6 of a second disc 4.

A wheel flange 8 is preferentially made of metal and stamped. This makes it possible to produce a low-cost part and control its manufacture and supply. As a result, the wheel flange 8 is conductive. To avoid short circuits, appropriate electrical insulation must be installed.

According to another feature, the rim 9 of the first wheel flange 8 has an L-shaped cross-section. One of the arms of the Lis arranged radially. The other arm of the L is arranged axially. The radial arm of the L thus forms a first bearing face 13. It is thus able to press axially against the periphery of a first disc 3 of said at least two discs 3, 4.

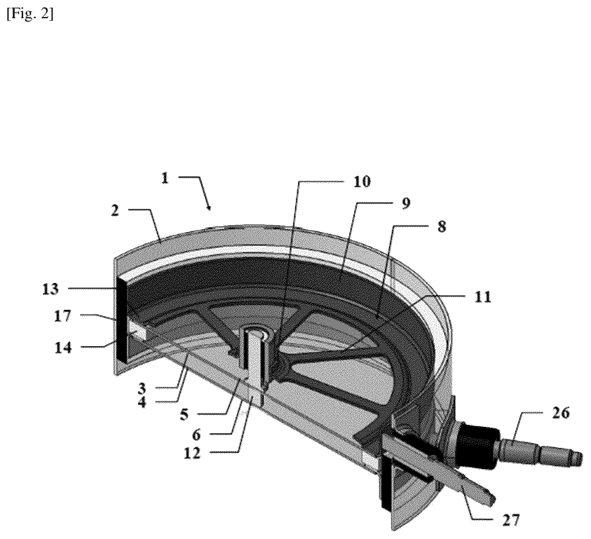

According to a first embodiment, more particularly illustrated in FIGS. 1-2, a heating element 1 comprises a first wheel flange 8 arranged outside said at least two discs 3, 4. The radial arm of the L bears against a disc 3, referred to as the adjacent disc 3. The axial arm of the L points outwards from said at least two discs 3, 4.

According to another feature of the first embodiment, the first wheel flange 8 is welded directly to the adjacent disc 3. This ensures mechanical reinforcement provided by the first wheel flange 8, which stiffens and thus supports the adjacent disc 3. The first wheel flange 8 is preferentially made of a metallic material and participates in the electrical circuit and connection between said at least two discs 3, 4.

In order to avoid short circuits, the at least two discs 3, 4 must be electrically insulated at carefully chosen points. To this end, according to another feature of the first embodiment, a first insulating rim 14 is arranged axially between said at least two discs 3, 4. This first insulating rim 14 is peripheral and covers at least the respective periphery of discs 3, 4. In addition, to complete the electrical insulation diagram and define the current flow path, the hub 10 is electrically insulated relative to the central electrode 12. This first insulating rim 14 is made, for example, of cord, typically fiberglass.

According to a further feature, described earlier, each of the discs 3, 4 respectively comprises a peripheral electrode 26, 27 connecting the periphery of the disc 3, 4.

Also, the electrical circuit for this first embodiment enters, via a first peripheral electrode 26, through the periphery of a first disc 3, passes radially through the first disc 3 to its center 5, continues, via the central electrode 12 to the center 6 of the second disc 4, passes radially through the second disc 3, from its center 6 to its periphery and exits via the second peripheral electrode 27, connected to said periphery. A current generator connected between the two peripheral electrodes 26, 27 circulates a current and heats the two discs 3, 4.

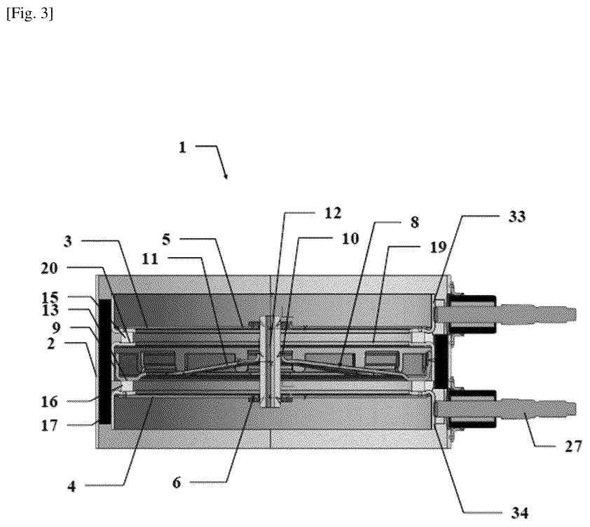

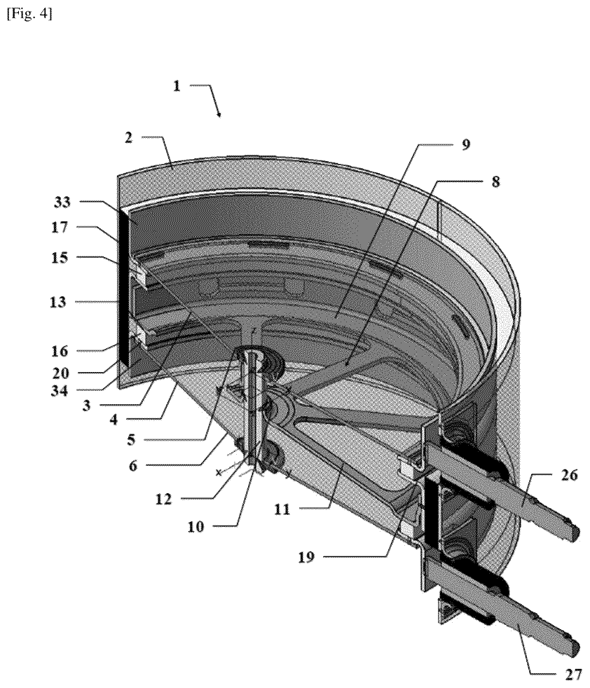

According to a second embodiment, more particularly illustrated in FIGS. 3-4, the first wheel flange 8 is arranged between said at least two discs 3, 4. In this case, the radial arm of the L bears against a first disc 3 and the axial arm of the L points towards a second disc 4.

In order not to create a short circuit via the first wheel flange 8, according to another feature of the second embodiment, the first wheel flange 8 is electrically insulated from the first disc 3 by a second insulating rim 15 axially interposed. This second insulating rim 15 is made, for example, of cord, typically fiberglass.

According to another feature of the second embodiment, the first wheel flange 8 is electrically insulated from the housing 2 radially by a first radial insulating mat 17. This radial insulating mat 17 is typically a fiberglass mat, also known as canning mat.

According to another feature of the second embodiment, in one example, the connector also comprises a single flange 19. This single flange 19 looks like a wheel flange but without the central part. The single flange 19 also includes a rim, similar to rim 9. This rim has an L-shaped cross-section. This cross-section is inverted relative to the cross-section of the rim 9 of the first wheel flange 8. Thus, the radial L arm forms a second bearing face 20 capable of bearing against the periphery of a second disc 4 of said at least two discs 3, 4. This single flange 19 is electrically insulated from said second disc 4 by a third insulating rim 16 axially interposed. This third insulating rim 16 is made, for example, of cord, typically fiberglass.

According to another feature of the second embodiment, the single flange 19 is electrically insulated from the housing 2, radially by the first radial insulating mat 17. This radial insulating mat 17 is typically a fiberglass mat, also known as canning mat.

In this second design, because of the insulation provided by the first radial insulating mat 17, there is no need for electrical insulation between the first wheel flange 8, at its hub 10, and the central electrode 12 carried by said hub 10.

Also, the electrical circuit, for this second embodiment, enters, via a first peripheral electrode 26, through the periphery of a first disc 3, traverses the first disc 3 to its center 5, continues, via the central electrode 12 to the second disc 4, traverses the second disc 4 to its periphery and exits via the second peripheral electrode 27. A current generator connected between the two peripheral electrodes 26, 27 circulates a current and heats the two discs 3, 4.

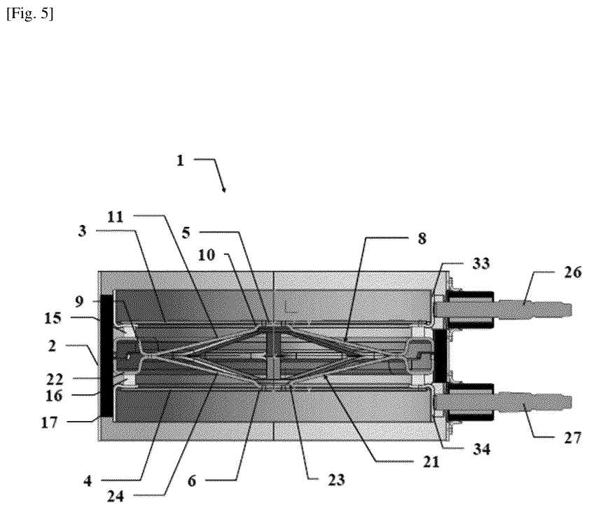

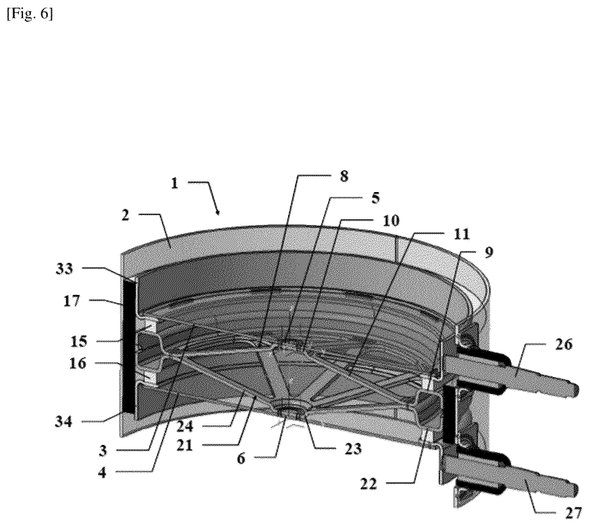

According to a third embodiment, more particularly illustrated in FIGS. 5-8, in one example, the connector comprises two substantially identical wheel flanges 8, 21. The first wheel flange 8 and the second wheel flange 21 are arranged head to tail and between two of said at least two discs 3, 4. The two wheel flanges 8, 21 are electrically connected to one another. This connection is achieved by bringing the rims 9, 22 into contact, possibly supplemented by welding. This contact is made via the respective bearing faces 13, 20.

Like the first wheel flange 8, the second wheel flange 21 comprises a rim 22, which substantially conforming to the periphery of the exhaust gas passage, a hub 23 and spokes 24 connecting the rim 22 to the hub 23.

Each of the wheel flanges 8, 21 is electrically connected to the respective discs 3, 4 via hubs 10, 23. A hub 10, 23 is electrically connected to the respective center 5, 6 of the adjacent disc 3, 4.

This is supplemented by electrical insulation of each of the rims 9, 22 by an axially interposed insulating rim 15, 16. These insulating rims 15, 16 are, for example, made of cord, typically fiberglass.

This is further supplemented by radial electrical insulation provided by a second radial insulating mat 18 arranged radially between the rims 9, 22 and single flanges 33, 34 in electrical contact with each of the discs 3, 4 respectively, at their periphery, the single flanges 33, 34 themselves being electrically insulated by the first radial insulating mat 17.

Also, the electrical circuit for this third embodiment enters, via a first peripheral electrode 26, the periphery of a first disc 3, passes through the first disc 3 to its center 5, continues via the hub 10 of the first wheel flange 8 through the first wheel flange 8, via its spokes 11, to its rim 9. The two rims 9, 22 are in contact and ensure the electrical connection between the two wheel flanges 8, 21. The current then passes to the second wheel flange 21, through the second wheel flange 21, via its spokes 24, to its hub 23. This hub 23 is connected to the center 6 of the second disc 4. The current then flows through the second disc 4 to its periphery and exits via the second peripheral electrode 27. A current generator connected between the two peripheral electrodes 26, 27 circulates a current and heats the two discs 3, 4.

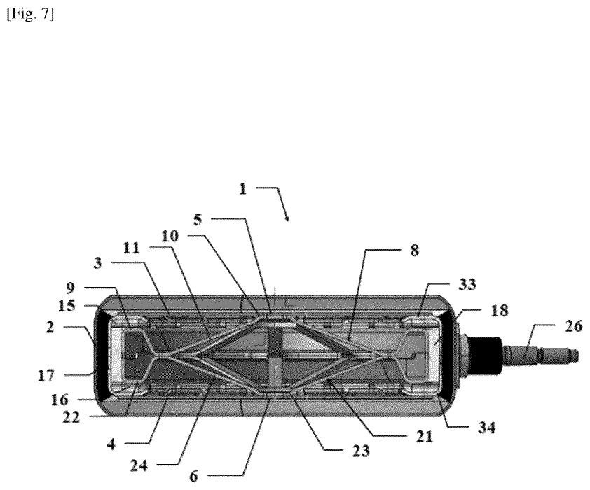

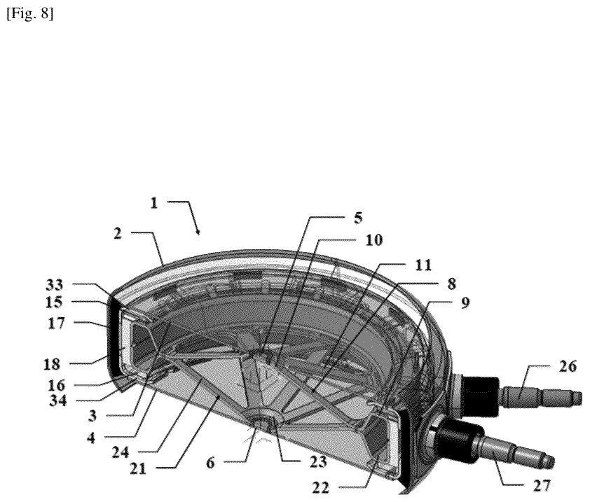

FIGS. 7 and 8 illustrate a variant of the third embodiment. The single flanges 33, 34, associated respectively with each of the discs 3, 4, are arranged with the radial arm of the L pointing outwards in the third embodiment. They are arranged with the radial arm of the L pointing inwards in the alternative embodiment. Furthermore, in the variant, the peripheral electrodes 26, 27 are arranged substantially in the same plane perpendicular to the axis. These two features make for a much more axially compact heating element 1.

In a fourth embodiment, in one example, the connector comprises a cylindrical slice 25 of metal foam. This cylindrical slice 25 is arranged between a first disc 3 and a second disc 4 of said at least two discs 3, 4. It is electrically connected to the first center 5 of the first disc 3 and to the second center 6 of the second disc 4. It thus takes on the role of the central electrode 12 in the two previous embodiments. On the other hand, it is electrically insulated axially from the rest of the first disc 3 by a second insulating rim 15 and electrically insulated axially from the rest of the second disc 4 by a third insulating rim 16. As a preferential option, the metal foam is coated with catalytic materials to produce a catalytic effect.

Also, the electrical circuit, for this fourth embodiment, enters, via a first peripheral electrode 26, through the periphery of a first disc 3, traverses the first disc 3, to its center 5, continues, via the cylindrical slice 25 of metal foam, to reach the center 6 of the second disc 4. The current then flows through the second disc 4 to its periphery and exits via the second peripheral electrode 27. A current generator connected between the two peripheral electrodes 26, 27 circulates a current and heats the two discs 3, 4.

According to a further feature common to the first, second, third and fourth embodiments, the heating element 1 further comprises, for each of said at least two discs 3, 4, a peripheral electrode 26, 27 electrically connected to the periphery of said disc 3, 4.

In order to make the electrical connection between the electrode 26, 27 and the associated disc 3, 4, a disc 3, 4 is advantageously arranged in a single flange 33, 34. This single flange 33, 34 has an L-shaped profile, similar to the single flange 19 already described for the second embodiment. Such a single flange 33, 34 makes it possible, via a radial L-arm, to give a disc 3, 4 an axial bearing face. This bearing face enables the disc 3, 4 to bear, for example, against an insulating rim 15, 16.

According to another feature, a heating element 1 according to one of the first, second or third embodiments may comprise at least one wheel flange 8, 21 incorporating a mixer. A mixer, for example, is obtained by shaping the spokes 11, 24 in the shape of fins. These fins can thus divert the flow of exhaust gases to a more specific area of a heating disc 3, 4 located downstream of the wheel flange 8, 21 or at a given angle of incidence. A mixer can thus divert exhaust gases so that they arrive on the surface of a heating disc 3, 4 with a grazing incidence.

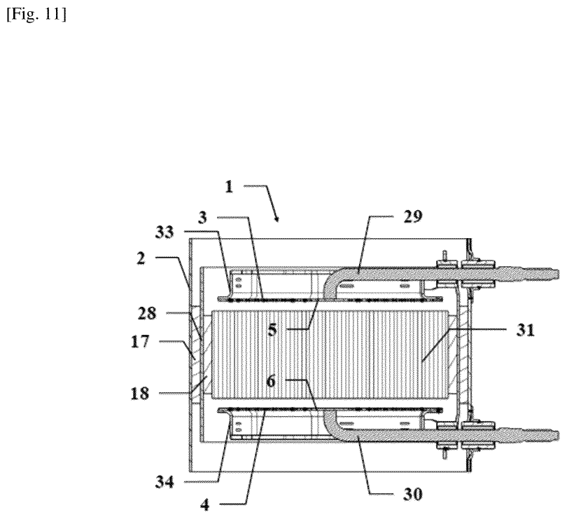

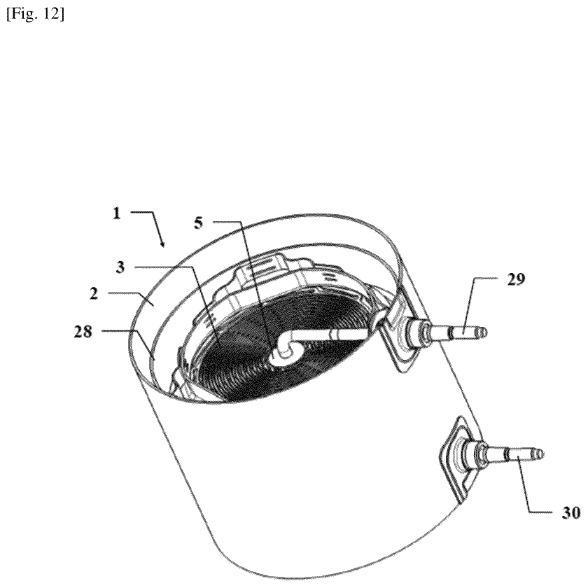

According to a fifth embodiment, more particularly illustrated in an example shown in FIGS. 11 and 12, the connector comprises a connector 28 of substantially tubular shape, matching the shape of the housing 2 from the inside. This connector 28 is conductive and is shaped so as to ensure an electrical connection, on the one hand with the periphery of a first disc 3, and on the other hand with the periphery of a second disc 4. Here, the connection between the heating discs 3, 4 is achieved by making contact between their peripheries, and not between their centers 5, 6 as in previous embodiments.

For this to work, the connector 28 must be insulated from the housing 2, for example by a radial insulating mat 17 arranged radially between the connector 28 and the housing 2. This radial insulating mat 17 is typically a fiberglass mat, also known as canning mat

As the two discs 3, 4 are connected at their periphery, the current must flow in and out through their respective centers 5, 6. To this end, according to a further feature, the heating element 1 also comprises a central electrode 29, 30 for each heating disc 3, 4. Each of these central electrodes 29, 30 is respectively electrically connected to the center 5, 6 of its associated disc 3, 4. Advantageously, this connection is made from the outside of the disc assembly 3, 4, so that the central electrode 29, 30 has easy access to the disc 3, 4.

We have seen that connector 28 is cylindrical, and advantageously hollow. The space between the heating discs 3 and 4 is also left free. According to another feature of the connector, it includes a catalytic brick 31, arranged between the discs 3, 4. This catalytic brick 31 thus makes use of vacant space while improving pollution control.

The disclosure has been illustrated and described in detail in the drawings and the preceding description. This must be considered as illustrative and given by way of example and not as limiting the disclosure to this description alone. Many alternative embodiments are possible.

### LIST OF REFERENCE SIGNS

1: heating element,
2: housing,
3, 4: heating disc,
5, 6: center,
8: first wheel flange,
9: rim,
10: hub,
11: spoke,
12: central electrode,
13: first bearing face,
14: first insulating rim,
15: second insulating rim,
16: third insulating rim,
17: first radial insulating mat,
18: second radial insulating mat,
19: single flange,
20: second bearing face,
21: second wheel flange,
22: rim,
23: hub,
24: spoke,
25: cylindrical slice,
26, 27: peripheral electrode,
28: connector,
29, 30: central electrode,
31: catalytic brick,
32: radial insulating mat,
33, 34: single flange.

1. A heating element for an exhaust line comprising:
a substantially tubular housing defining a passage section for exhaust gases;
at least two heating discs arranged across the passage section to force the exhaust gases to pass through said at least two heating discs; and
a connector that supports the at least two heating discs and provides an electrical connection between the at least two heating discs.

2. The heating element according to claim 1, wherein the connector comprises a first wheel flange and a central electrode, the first wheel flange comprising:
a rim, substantially conforming to a periphery of the passage section for the exhaust gases;
a hub that supports the central electrode; and
spokes connecting the rim to the hub, the central electrode electrically connecting respective centers of the at least two heating discs.

3. The heating element according to claim 2, wherein the rim of the first wheel flange has an L-shaped cross-section, with one arm of the L-shaped cross-section arranged radially to provide a radial arm and another arm of the L-shaped cross-section arranged axially to provide an axial arm, the radial arm of the L-shaped cross-section forming a first bearing face that can bear axially against a periphery of a first disc of the at least two heating discs.

4. The heating element according to claim 3, wherein the first wheel flange is arranged on an outside of the at least two heating discs, the radial arm bearing against an adjacent disc of the at least two heating discs and the axial arm pointing outwards.

5. The heating element according to claim 4, wherein the first wheel flange is welded to the adjacent disc.

6. The heating element according to claim 4, wherein a first insulating rim is arranged axially between the at least two heating discs and wherein the hub is electrically insulated relative to the central electrode.

7. The heating element according to claim 3, wherein the first wheel flange is arranged between the at least two heating discs, the radial arm bearing against a first disc of the at least two heating discs and the axial arm pointing towards a second disc of the at least two heating discs.

8. The heating element according to claim 7, wherein the first wheel flange is electrically insulated from the first disc by an axially interposed second insulating rim.

9. The heating element according to claim 7, wherein the first wheel flange is electrically insulated from the substantially tubular housing radially by a first radial insulating mat.

10. The heating element according to claim 7, wherein the connector further comprises a single flange comprising a rim with an L-shaped cross-section, reversed relative to a cross-section of the rim of the first wheel flange, to form a second bearing face that can bear against a periphery of a second disc of the at least two heating discs, and wherein the single flange is electrically insulated from the second disc by a third insulating rim axially interposed therebetween.

11. The heating element according to claim 10, wherein the single flange is electrically insulated from the substantially tubular housing radially by a first radial insulating mat.

12. The heating element according to claim 1, wherein the connector comprises a first wheel flange and a second wheel flange, mounted head-to-tail between two discs of the at least two heating discs, wherein the first wheel flange and the second wheel flange are electrically connected to one another, one of the first wheel flange and the second wheel flange comprising a rim, substantially conforming to a periphery of the passage section for the exhaust gases, a hub, and spokes connecting the rim to the hub, one hub being electrically connected to a respective center of an adjacent disc of the two discs and one rim being electrically insulated from the adjacent disc by an insulating rim axially interposed therebetween.

13. The heating element according to claim 1, wherein the connector comprises a cylindrical slice of metallic foam that is arranged between a first disc and a second disc of the at least two heating discs, the cylindrical slice of metallic foam being electrically connected with a first center of the first disc and with a second center of the second disc, and wherein the cylindrical slice of metallic foam is axially electrically insulated from a rest of the first disc by a second insulating rim and is axially electrically insulated from a rest of the second disc by a third insulating rim.

14. The heating element according to claim 2, wherein the first wheel flange incorporates a mixer.

15. The heating element according to claim 1, wherein the connector comprises a substantially tubular shape, conforming internally to a shape of the substantially tubular housing to provide an electrical connection between respective peripheries of the at least two heating discs.

16. The heating element according to claim 15, further comprising for each of the at least two heating discs, a central electrode respectively electrically connected to a center of a disc of the at least two heating discs, from an outside.

17. The heating element according to claim 15, wherein the connector further comprises a catalytic brick, arranged between the at least two heating discs.

18. The heating element according to claim 13, wherein the cylindrical slice of metallic metal foam is coated to produce a catalytic effect.
